(19) United States
(12) Patent Application Publication
(10) Pub. No.: US 2025/0342146 A1
(43) Pub. Date: Nov. 6, 2025

(54) SYSTEM AND METHOD FOR LINEARIZABLE LEADER READ OPTIMIZATION IN RAFT

(71) Applicant: MongoDB, Inc., New York, NY (US)

(72) Inventors: Murat Demirbas, West Lafayette, IN (US); A. Jesse Jiryu Davis, New Paltz, NY (US); Matthew Russotto, West Orange, NJ (US)

(73) Assignee: MongoDB, Inc., New York, NY (US)

(21) Appl. No.: 19/194,296

(22) Filed: Apr. 30, 2025

Related U.S. Application Data
(60) Provisional application No. 63/641,015, filed on May 1, 2024.

(51) Int. Cl. G06F 16/23; G06F 16/27

(52) U.S. Cl. CPC G06F 16/2322; G06F 16/27

(57) ABSTRACT

A system and method for linearizable leader read optimizations in Raft are provided. According to one aspect, leader leases enable serving linearizable reads locally at the leaseholding leader without the cost and latency of communication with the followers. By leveraging the benefits of Raft log guarantees, the novel leader lease protocol of some embodiments simplifies complexity of lease management implementation and improves write and read availability during leader transitions.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### RELATED APPLICATION

This application claims the benefit under 35 U.S.C. § 119 (e) of U.S. provisional patent application Appl. No. 63/641,015, entitled “SYSTEM AND METHOD FOR LINEARIZABLE LEADER READ OPTIMIZATION IN RAFT”, filed May 1, 2024, which is herein incorporated by reference in its entirety.

### FIELD OF THE INVENTION

The present invention relates generally to the field of distributed systems, more particularly to systems and methods for fault-tolerant replication of a database.

### BACKGROUND OF THE INVENTION

Systems exist that attempt to ensure operations are performed consistently across distributed systems. There are many different solutions for determining a consensus across multiple systems, especially when performing operations such as updates to a distributed database. In one such type of system, a primary node keeps an account of journaled operations performed on the database. It is appreciated that there are failures within such systems. Thus, it is preferable to have one or more secondary systems that can take over applying database writes if the primary fails. However, there are tradeoffs between detecting failures in a timely manner while ensuring few failovers and rollback scenarios.

The Paxos family of leader-based consensus protocols are commonly employed for fault-tolerant replication of database systems, as explained in L. Lamport, “Paxos made simple,” ACM SIGACT News, vol. 32, no. 4, pp. 18-25, 2001; S. Zhou and S. Mu, “{Fault-Tolerant} replication with {Pull-Based} consensus in {MongoDB},” in 18th USENIX Symposium on Networked Systems Design and Implementation (NSDI 21), 2021, pp. 687-703; J. C. Corbett, J. Dean, M. Epstein, A. Fikes, C. Frost, J. J. Furman, S. Ghemawat, A. Gubarev, C. Heiser, P. Hochschild et al., “Spanner: Google's globally distributed database,” ACM Transactions on Computer Systems (TOCS), vol. 31, no. 3, p. 8, 2013; R. Taft, I. Sharif, A. Matei, N. VanBenschoten, J. Lewis, T. Grieger, K. Niemi, A. Woods, A. Birzin, R. Poss et al., “CockroachDB: The resilient geo-distributed sq1 database,” in Proceedings of the 2020 ACM SIGMOD international conference on management of data, 2020, pp. 1493-1509; and R. Van Renesse and D. Altinbuken, “Paxos made moderately complex,” ACM Computing Surveys (CSUR), vol. 47, no. 3, pp. 1-36, 2015. The contents these five documents are herein incorporated by reference in their entirety. MultiPaxos implements state machine replication (SMR) and provides fault-tolerance against crash failure of a minority of the nodes to the face of asynchronous execution and the many corner cases possible during a leader failover.

MultiPaxos SMR operates by serializing state-mutating operations from the leader to the followers. To serve a linearizable read, the leader also serializes it as a no-op (no update operation) and only serves the read upon hearing acknowledgement to the no-op from a quorum of followers. Serving linearizable reads this way incurs communication, which incurs latency, I/O contention, and even monetary costs on the cloud. Many databases, including MongoDB, pay this cost for linearizable reads, because performing a local read at the leader is not guaranteed to be linearizable. It is possible that, unbeknownst to this leader, another leader may emerge by clearing phase-1 of Paxos from a quorum of nodes not involving the original leader, and may commit updates. The original leader would then be serving stale reads when serving reads locally. Clearing a no-op with a quorum prevents this scenario, as it establishes that the leader was not dethroned at the read request time.

In order to reduce the linearizable read cost, leader lease may be optimized, as described in T. D. Chandra, R. Griesemer, and J. Redstone, “Paxos made live: an engineering perspective,” in Proceedings of the twenty-sixth annual ACM symposium on Principles of distributed computing, 2007, pp. 398-407, the contents of which are herein included in their entirety. A leader lease ensures that any replica set has only one writable primary at a time. This enables a leaseholder leader to serve linearizable reads locally (without the communication cost with the followers), since the lease prevents another leader to emerge and perform writes.

The leader lease idea is outlined in several publications, both for Paxos and Raft, including T. D. Chandra, R. Griesemer, and J. Redstone, “Paxos made live: an engineering perspective,” in Proceedings of the twenty-sixth annual ACM symposium on Principles of distributed computing, 2007, pp. 398-407; and D. Ongaro, “Consensus: Bridging theory and practice,” Ph.D. dissertation, Stanford University, 2014. The contents of these two publications are herein incorporated by reference in their entirety. However, the descriptions in these publications are at a high level, and do not disclose the mechanics of implementation. While there have been many implementations of Raft protocol, implementation of leader leases has been sporadic and troubled with problems.

Raft provides a restricted version of MultiPaxos, in that a new leader must be a fully caught-up replica with the longest log, while MultiPaxos can pick any node as a leader and recover missing log entries. This strong leader property in Raft provides new opportunities to explore for leader leases. An example of such a system is described in more detail in U.S. Application 62/343,546 entitled “SYSTEM AND METHOD FOR DETERMINING CONSENSUS WITHIN A DISTRIBUTED DATABASE,” incorporated herein by reference. Previous work, however, failed to explore these Raft opportunities, and thus, there exists a need for a system and method that utilize this strong leader principle of Raft for linearizable lead read optimization.

### SUMMARY OF THE INVENTION

As discussed above, determining a consensus across multiple systems while guaranteeing a read to be linearizable and reducing the read latency and cost is challenging. The present invention addresses this challenge with a novel leader lease protocol, LeaseGuard, that leverages the benefits of Raft log guarantees. In some embodiments, a new leader may serve local linearizable reads (alongside the leader it deposed) by piggybacking on the deposed leader's lease duration. This surprising optimization reduces read unavailability concerns when using leader leases. Optionally, a staged-write optimization alleviates write unavailability concerns as well.

In some aspects, the leader take-over unavailability problem that prior lease protocols suffer from is reduced. A leader lease ensures that any replica set has only one writable primary/leader at a time. This enables the leaseholder leader to serve linearizable reads locally (without the communication cost with the followers), since the lease prevents another leader to emerge and perform writes. By leveraging the Raft protocol's log-matching guarantees on leader election, some aspects include a novel leader lease protocol that solves a major disadvantage with previous lease implementations: leader take-over unavailability induced by waiting on the previous leader's lease to expire.

To address this unavailability problem, some aspects modify the design and implementation of leases significantly. In some aspects, the lease protocol keeps intact the leader election procedure (BecomeLeader action) of the original Raft implementation. There is no checking or waiting for leases when electing a new leader, which helps address the concerns about unavailability in leader handover induced by leader leases as it allows us to overlap leader election to be within the lease duration of the previous leader. The lease acquisition and extension at the followers occur as they stream new log entries written by the leader, as part of the replication protocol. The lease acquisition and extension at the leader occurs when the leader learns of majority replication and commits a log entry. This simplified design and implementation also results in cleaner rules and correctness arguments for leader leases.

In some aspects, leader take-over unavailability is further reduced in the presence of outstanding leases by allowing useful work to be done when a new leader is elected but there is still time on the previous leader's lease duration. A new leader may serve local linearizable reads (alongside the leader it deposed) by piggybacking on the deposed leader's outstanding lease duration. This surprising optimization completely eliminates read unavailability concerns when using leader leases. In some aspects, a staged-write optimization alleviates write unavailability concerns as well. This works by overlapping replication of log entries to followers to stage these to be ready for commit, and only delaying the commit and client-notification until the expiration of the previous leader's lease duration. Formal modeling and correctness proofs show why these optimizations are safe.

By decoupling the election timeout from the lease duration in some aspects, both may be tuned separately. In particular, the election timeout can be tuned only by taking the heartbeat time into account, without being constrained by the lease duration. As such, the election timeout can be (and often should be) less than lease duration, and this brings availability and performance improvement benefits.

The lease protocol of some embodiments of the present invention simplifies the implementation significantly. The BecomeLeader action remains unchanged from the original Raft implementation, and lease acquisition and extension at the followers and the leader occur through the GetEntries and CommitEntry actions respectively. The preconditions for accepting/serving ClientWrite and ClientRead request are succinct. The simplified implementation of some embodiments of the present invention also results in cleaner rules and correctness arguments for leader leases.

Some embodiments of the present invention include several MongoDB specific contributions. The default consistency options are for writes to be acknowledged by majority before acknowledging (w: majority), and the read to be executed locally at the leader (rc: local). This violates read-your-writes guarantees upon a leader failover: the new leader may update the state, but the deposed leader serving a read locally would violate the read-your-writes guarantee. Some embodiments of the present invention add leader leases to prevent this problem, because the new leader would not be able to update any values, until the deposed leader's lease expires.

According to one aspect, a database management system comprising a plurality of nodes is provided wherein at least one of the plurality of nodes configured to: initiate a request to become a new leader of a lease; receive a client write request; service the client write request only if the lease belongs to a current term of the at least one node or if the lease belongs to another of plurality of nodes serving as an old leader and is expired; and decline the client write request if the lease belongs to the old leader and is not expired.

According to another aspect, the database management system may further comprise a component to become a leader, wherein the initiate a request to become a new leader of a lease invokes the become leader component. According to another aspect, the database management system may further comprise a plurality of logs corresponding to the plurality of nodes, each of the plurality of logs comprising a plurality of entries. According to another aspect, the component to become a leader may be configured to permit the at least one node to become the new leader only if the log corresponding to the at least one node comprises the plurality of entries of the log of the node that is the old leader.

According to another aspect, the database management system may further comprise a component for matching logs configured to indicate that a portion of the plurality of entries of a first log of the plurality of logs corresponding to a first node of the plurality of nodes is the same as a portion of the plurality of entries of a second log of the plurality of logs corresponding to a second node of the plurality of nodes. According to another aspect, the database management system may further comprise a component for ensuring leader completeness configured to ensure that the plurality of entries in a log of the new leader is the same as a plurality of entities in a log of the old leader. According to another aspect, the at least one node is further configured to determine whether the lease belongs to the old leader by invoking the component for matching logs and the component for ensuring leader completeness. According to another aspect, the lease comprises a current term and an expiration time. According to another aspect, the at least one node is further configured to extend the expiration time of the lease after the at least one node becomes the new leader.

According to another aspect, the new leader is configured to receive a client read request, wherein the client read request specifies a query; determine if the query corresponds to one or more entries in a limbo region of the new leader; and reject, upon the determination, the client read request.

According to another aspect, the database management system further comprises a component configured to get one or more of the plurality of entries and a component configured to commit the one or more of the plurality of entries wherein the extend the expiration time of the lease comprises invoking the component to get entries and the component to commit entries.

In another aspect, the method may further comprise receiving a client read request, wherein the client request specifies a query; determining if the query corresponds to one or more entries in a limbo region of the new leader; and rejecting, upon the determination, the client read request.

In addition, a computer-implemented method for managing a database comprising a plurality of nodes is provided, the method comprising initiating a request by at least one of the plurality of nodes to become a new leader of a lease comprising a current term and an expiration time; receiving a client write request at the at least one node; servicing the client write request at the at least one node if the lease belongs to the current term of the at least one node or if the lease belongs to another of the plurality of nodes serving as an old leader and is expired; and declining the client write request at the at least one node if the lease belongs to the old leader and is not expired.

According to another aspect, the method may further comprise a plurality of logs corresponding to the plurality of nodes, each of the plurality of logs comprising a plurality of entries. According to another aspect, the method may further comprise permitting the at least one node to become the new leader only if the log corresponding to the at least one node comprises the plurality of entries of the log of the node that is the old leader. According to another aspect, the method may further comprise ensuring that a portion of the plurality of entries of a first log of the plurality of logs corresponding to a first node of the plurality of nodes is the same as a portion of the plurality of entries of a second log of the plurality of logs corresponding to a second node of the plurality of nodes. According to another aspect, the method may further comprise ensuring that the plurality of entries in a log of the new leader is the same as a plurality of entities in a log of the old leader. According to another aspect, the method may further comprise extending the expiration time of the lease after the at least one node becomes the new leader. Optionally, the extending the expiration time of the lease may comprise getting one or more of the plurality of entries; and committing the one or more of the plurality of entries. In another aspect, the method may further comprise receiving a client read request at the old leader; and servicing the client read request if the lease belongs to the old leader and is not expired. In another aspect, the method may further comprise receiving a client read request, wherein the client request specifies a query; determining if the query corresponds to one or more entries in a limbo region of the new leader; and rejecting, upon the determination, the client read request.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure.

FIG. 1 illustrates three phases of Paxos protocol.

FIG. 2 illustrates MultiPaxos optimization.

FIG. 3 illustrates Raft replication.

FIG. 4 illustrates the pseudocode of LeaseGuard.

FIG. 5 illustrates transitions in the read/write capabilities of leaders.

FIG. 6 illustrates limbo region in a new leader's log.

FIG. 7 illustrates the effect of lease duration on availability.

FIG. 8 illustrates the effect of network latency on read/write latency.

FIG. 9 illustrates availability.

FIG. 10 illustrates the effect of workload skewness on read throughput.

FIG. 11 illustrates the effect of network latency on read/write latency from the experimental evaluation.

FIG. 12 illustrates availability from the experimental evaluation.

FIG. 13 illustrates a block diagram of a distributed computer system 1300, in which various aspects and functions are practiced.

### DETAILED DESCRIPTION

Consensus protocols, such as Raft and MultiPaxos, allow the leader to serve linearizable reads locally while avoiding the cost and latency of communication with followers. However, implementing leader lease in practice is complex and error prone, especially during leader transitions. For example, a prior leader lease approach hurts availability, as a deposed leader's lease must expire before a new leader can process reads and writes. A prior leader lease approach also risks gray failures, because a leader can continue renewing its lease but fail to execute tasks due to internal issues such as disk failure.

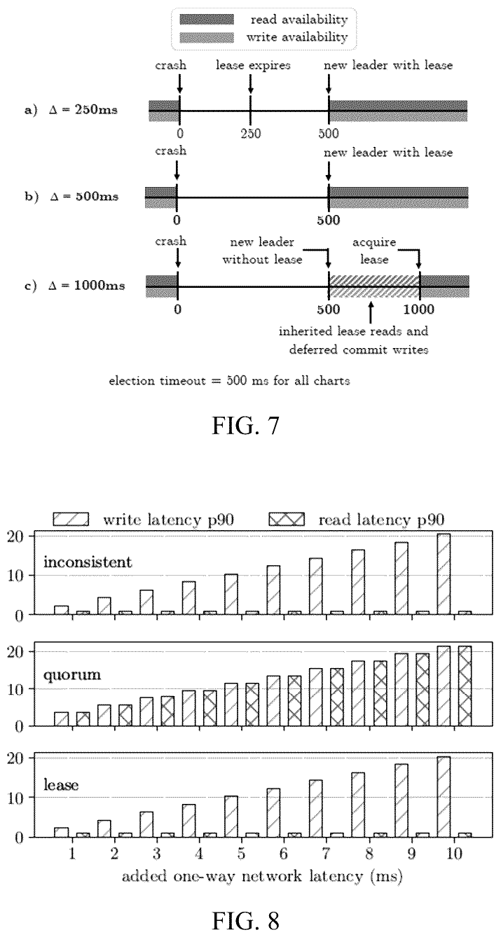

Upon recognizing these technical challenges, the inventors have appreciated the need for techniques that simplify lease management and maximize availability during leader transitions. LeaderGuard solves this challenge by maximizing write and read availability, while preserving Raft's election procedure. The performance of LeaderGuard is assessed under the simulation and experimental evaluation, as discussed below referring to FIGS. 7-12.

Following below are more detailed descriptions of various concepts related to, and embodiments of, linearizable leader read optimization in Raft. Various aspects of at least one example are discussed below with reference to the accompanying figures, which are not intended to be drawn to scale. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure.

### Consensus Protocol: MultiPaxos

There are three phases in Paxos, a predecessor of Raft. FIG. 1 illustrates three phases of Paxos protocol. Phase1 establishes some node as the leader, Phase2 lets the leader to impose its will onto the followers by telling what command to accept, and Phase3 informs the followers that consensus was reached. The vanilla Paxos protocol is inefficient as it employs three communication phases for consensus on each SMR log-entry.

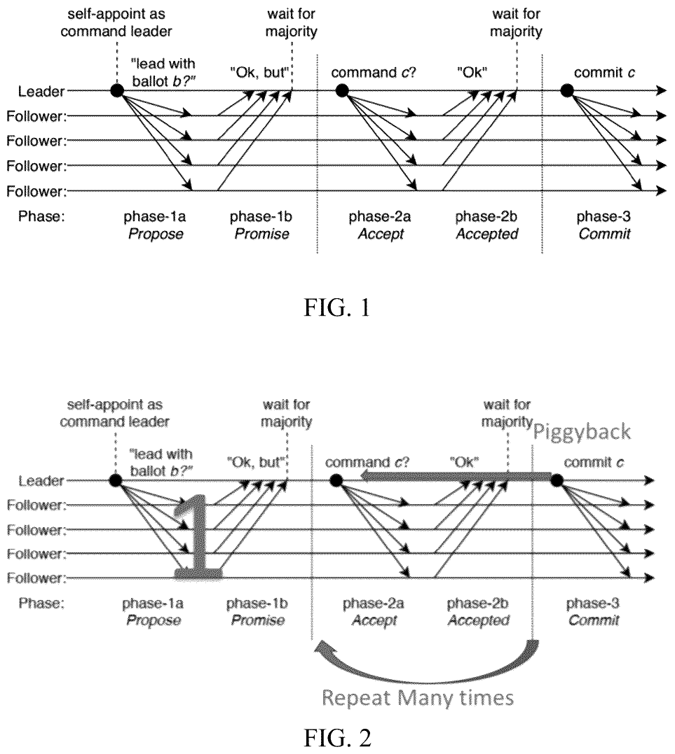

Referring to FIG. 2, the MultiPaxos optimization is adopted to cut down the unnecessary pleasantries. MultiPaxos elects one node as a stable leader for a prolonged time and repeats Phase2 as many times possible under the same leader without needing to perform another Phase1. In other words, the leader skips Phase and just goes with Phase2 for consensus instances on upcoming log-entries. For further communication efficiency, as shown in FIG. 2, Phase3 messages are piggybacked to the Phase2 messages of upcoming slots rather than being sent separately.

### Consensus Protocol: Raft

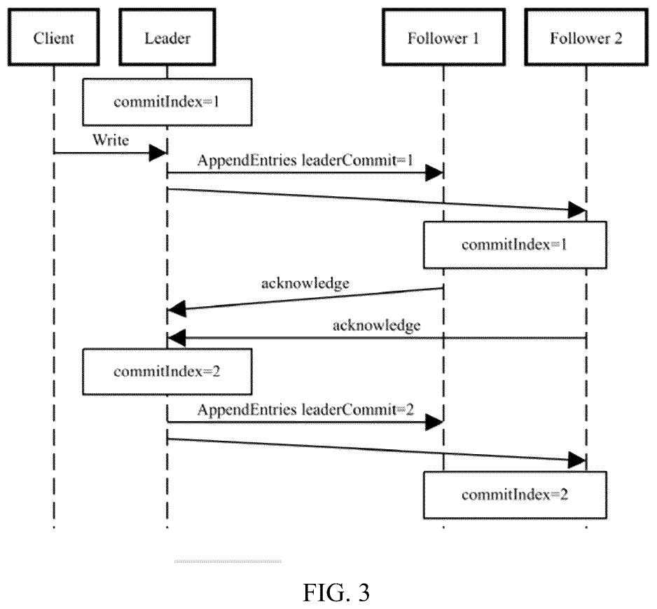

Raft is a leader-based state machine replication (SMR) protocol. Referring to FIG. 3, in Raft, each node has a state: leader, candidate, or follower. Each node has a term which tracks the highest term number it has seen. During communication, nodes gossip their term numbers. To run for election, a follower increments its term and becomes a candidate, then requests votes from a majority of the replica set. Once elected, a node remains a leader until it crashes or observes another node with a higher term.

Raft aims to improve understandability and simplify the implementation of its predecessor MultiPaxos protocol, as described in D. Ongaro and J. K. Ousterhout, “In search of an understandable consensus algorithm.” in USENIX Annual Technical Conference, 2014, pp. 305-319, the contents of which are herein incorporated by reference in its entirely. Indeed, open-source implementations of Raft have become a popular choice for SMR in many distributed systems, as described in S. Zhou and S. Mu, “{Fault-Tolerant} replication with {Pull-Based} consensus in {MongoDB},” in 18th USENIX Symposium on Networked Systems Design and Implementation (NSDI 21), 2021, pp. 687-703 and R. Taft, I. Sharif, A. Matei, N. VanBenschoten, J. Lewis, T. Grieger, K. Niemi, A. Woods, A. Birzin, R. Poss et al., “CockroachDB: The resilient geo-distributed sq1 database,” in Proceedings of the 2020 ACM SIGMOD international conference on management of data, 2020, pp. 1493-1509.

FIG. 3 illustrates Raft replication. Clients invoke commands on the leader, which records them as entries in its log and sends them to followers in AppendEntries messages. Followers record entries in their own logs in the same order. An entry's log index is its position in the log. Each node has a commitIndex, the index of the latest entry it knows is durable. When the leader learns that a majority of nodes (including itself) have replicated up to a given log index, it advances its commitIndex to that point. It applies committed entries' commands to its local state machine and updates its lastApplied index. The leader then replies to waiting clients, confirming their commands have succeeded. Followers eventually learn the leader's new commitIndex, which the leader sends them in subsequent AppendEntries messages. Thus, followers' commitIndexes are less than or equal to the leader's in normal operation.

Raft and its predecessor MultiPaxos are similar, especially in the “happy-case” operations, as described in H. Howard and R. Mortier, “Paxos vs raft: Have we reached consensus on distributed consensus?” in Proceedings of the 7th Workshop on Principles and Practice of Consistency for Distributed Data, 2020, pp. 1-9; and Z. Wang, C. Zhao, S. Mu, H. Chen, and J. Li, “On the parallels between paxos and raft, and how to port optimizations,” in Proceedings of the 2019 ACM Symposium on Principles of Distributed Computing, 2019, pp. 445-454. The contents of these two publications are herein incorporated by reference in their entirety.

The important difference between Raft and MultiPaxos is the leader-election phase of the protocols. In Raft, a new leader must be a fully caught-up replica with the longest log, while MultiPaxos can pick any node as a leader and recover missing log entries. This strong leader property allows the new leader in Raft to start quickly since it does not need to learn any missing entries. In some embodiments, this strong leader property is the key to optimizations for leader lease implementation in Raft.

### Linearizable Read

Guaranteeing a read to be linearizable is one of the requirements. Linearizability, also known as strong consistency, requires that (1) each operation (from client perspective) appear to occur at an instantaneous point between its start time (when the client submits it) and finish time (when the client receives the response), and (2) execution at these instantaneous points form a valid sequential execution. That is, it should be as if operations are executed by a single thread atomically.

Linearizability ensures that a read operation for an object returns the value that was last written for that object. This is complicated by the fact that the exact point the write or read takes effect is hidden. It is known that a write or read must take effect atomically between invocation and response of the corresponding operation, but the serialization point is not known.

Consider, for example, this trace for Puts and Gets on a single object. PutReq(a) PutReq(b) PutResp(b) PutResp(a) GetReq( ) GetResp(?) Since the Put with the values a and b overlap (since the PutReq and PutResp are interleaved for a and b), when a Get is performed at the end, it is acceptable to receive GetResp(a) or GetResp(b) and this still being linearizable. If we get a GetResp(a), it is possible that Put(b) is serialized before Put(a). If we get a GetResp(b), it is possible that Put(a) is serialized before Put(b).

### Novel Optimization: LeaseGuard

LeaseGuard is a novel optimization that solves above-mentioned challenges of complexity of implementation and errors associated with leader transitions. LeaseGuard relies on Raft, thereby guaranteeing linearizable read and leader completeness (a newly elected leader already has all log entries that were replicated by a majority in the previous term).

In LeaseGuard, the log is the lease. Followers learn about leases through existing Raft replication messages shown in FIG. 3. The leader establishes or extends its lease by confirming replication of its log entries to a majority of nodes. There are no new data structures or messages for leases. This simplifies implementation and enables clean correctness arguments. It also solves the faux-leader problem: only a leader who can make real progress can maintain its lease.

LeaseGuard minimizes write unavailability through its deferred-commit writes optimization. This allows the new leader to write and replicate log entries before the deposed leader's lease expires. LeaseGuard also minimizes read unavailability through its inherited lease reads optimization, enabling a new leader to serve local linearizable reads concurrently with a deposed leader.

Leader-based consensus systems currently face a tradeoff between availability and consistency. For example, aggressively replacing a leader suspected of failure improves availability, but increases the risk of inconsistency from multiple leaders. Conventional lease protocols optimize consistency over availability. LeaseGuard, on the other hand, guarantees consistency while improving availability over conventional lease protocols.

Both the simulation and experimental evaluation confirm the effectiveness of LeaseGuard, as described below referring to FIGS. 7-12.

### Implementation of LeaseGuard

A TLA+ model of LeaseGuard is described in https://github.com/will62794/logless-reconfig/blob/master/MongoStaticRaft.tla, the contents of which are herein incorporated in their entirety.

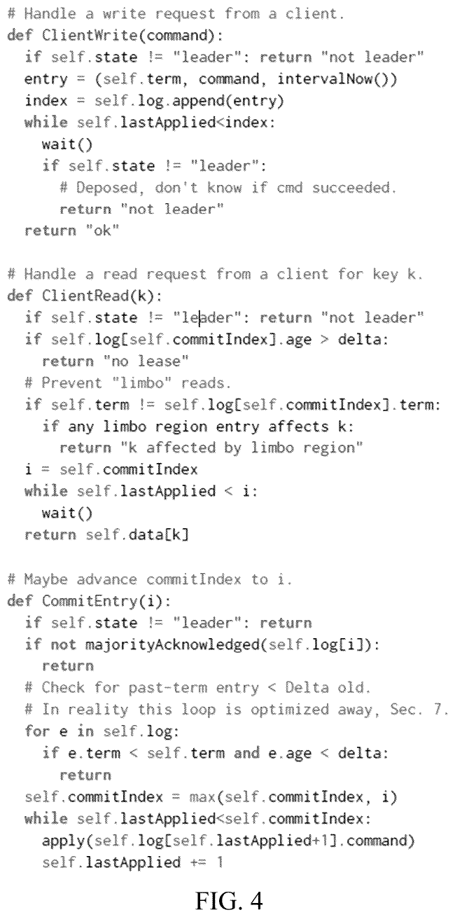

FIG. 4 illustrates pseudocode of exemplary implementation of LeaseGuard. This implementation assumes that each node has access to clocks with bounded uncertainty, called function intervalNow( ) that returns the interval [earliest, latest]. It is guaranteed that the true time was in this interval for at least a moment between the function's invocation and completion. LeaseGuard requires a node to decide if a time recorded on another node is now more than Δ old, for some duration Δ. For any two time intervals t1 and t2, a node knows that t1 is more than Δ old if intervalNow( ) has returned t2 and t1.latest+Δ<t2.earliest. Details of this exemplary implementation for handling a write request, a read request, and advancing the commitIndex are discussed below.

The leader lease design of some embodiments of LeaseGuard leaves the BecomeLeader action unchanged, in contrast to prior systems as described in J. C. Corbett, J. Dean, M. Epstein, A. Fikes, C. Frost, J. J. Furman, S. Ghemawat, A. Gubarev, C. Heiser, P. Hochschild et al., “Spanner: Google's globally distributed database,” ACM Transactions on Computer Systems (TOCS), vol. 31, no. 3, p. 8, 2013, and R. Taft, I. Sharif, A. Matei, N. VanBenschoten, J. Lewis, T. Grieger, K. Niemi, A. Woods, A. Birzin, R. Poss et al., “CockroachDB: The resilient geo-distributed sq1 database,” in Proceedings of the 2020 ACM SIGMOD international conference on management of data, 2020, pp. 1493-1509. Since reducing unavailability due to lease waiting is prioritized, a new leader is allowed to emerge before the old leader's lease expires. That is, even a node bound by a lease may invoke BecomeLeader and become elected with higher term. The new leader in some embodiments, however, must decline serving a ClientWrite in the presence of an outstanding lease, as that may lead to the leaseholder old leader to serve a stale ClientRead relying on its lease.

Even for guarding and delaying the ClientWrite action, the new leader is not required to explicitly learn about the existing leases from its vote quorum. This is also in contrast to the existing lease implementation strategies described in J. C. Corbett, J. Dean, M. Epstein, A. Fikes, C. Frost, J. J. Furman, S. Ghemawat, A. Gubarev, C. Heiser, P. Hochschild et al., “Spanner: Google's globally distributed database,” ACM Transactions on Computer Systems (TOCS), vol. 31, no. 3, p. 8, 2013, and R. Taft, I. Sharif, A. Matei, N. VanBenschoten, J. Lewis, T. Grieger, K. Niemi, A. Woods, A. Birzin, R. Poss et al., “CockroachDB: The resilient geo-distributed sq1 database,” in Proceedings of the 2020 ACM SIGMOD international conference on management of data, 2020, pp. 1493-1509. As discussed below for the ClientWrite action, the learning of deposed leader lease may be readily established thanks to the LogMatching and LeaderCompleteness guarantees provided by Raft.

### 1. Establishing and Extending a Lease

In some embodiments, leases are established and extended by Raft's replication protocol, as shown in FIG. 3. A leader establishes a lease on followers by creating an entry in its log and sending it to flowers. When the leader commits the entry, after hearing acks from a majority of nodes, the leader knows that it can serve reads, and it further knows that no future leader will advance the commitIndex until the entry is more than Δ old. Once the entry is committed, Leader Completeness implies that any leader in a future term will have the entry in its log, and thus know of the leader's lease. Later entries, including ordinary client write commands, serve to automatically extend the lease.

In some embodiments, the followers establish/extend lease via the GetEntries action using the highest term leader they know of. In some embodiments, the lease is a tuple: the first part denotes the currentTerm of the leaseholder leader, and the second the time the lease expires. A new leader in some embodiments, in turn, establishes/extends its lease with CommitEntry, because this assures the leader that a majority of nodes know of its lease.

In some embodiments, leases may get naturally extended as part of GetEntries and CommitEntry during replication of oplog entries. A lease may be set to be the OpTime of the Entry+Δ. If replication was late and A small, this may not increase the lease to be current, but that is acceptable.

In some embodiments, for a cluster that has infrequent writes, if there is nothing to write during lease duration, the lease may fail to be extended. If the leader cares to have leases and serve reads locally, it can publish no-op heartbeats to extend this. For write-infrequent clusters, this communication cost may be reduced by using adaptive leases with increased lease duration.

### 2. ClientWrite's Deferred Commit Writes

Prior systems do not allow a non-leaseholder to accept writes. In contrast, LeaseGuard allows a leader to accept writes, send writes to followers, and make them fault-tolerantly durable. It simply cannot commit, apply, or acknowledge writes until its latest prior-term entry is more than Δ old. This concept is referred to as the deferred commit optimization. When the prior-term entry is old enough, the leader advances its commitIndex to the index of the latest majority-replicated entry and acknowledges all the pending writes that are now committed.

This optimization is computationally advantageous as it lets the leader prepare writes to be committed as soon as the old lease expires, without more followers communication. Even if the leader crashes or is deposed before these writes are committed, they are durable once majority-replicated and will be committed by a future leader.

In some embodiments, a newly elected leader can serve a ClientWrite only after the old leader's lease expires. To achieve this effect, the ClientWrite (i) may be guarded by:

$$∧ state [ i ] = Primary$$

$$∧ ( lease [ i ] [ 2 ] < clock$$

$$∨ lease [ i ] [ 1 ] = currentTerm [ i ] )$$

This condition states that a leader i can serve a ClientWrite if either the lease is expired or the lease belongs to i's currentTerm. In other words, if the lease does not belong to i, this new leader node i is obligated to wait until the lease expires.

For the first disjunct case, if this lease is a vacuous lease (i.e., no lease), satisfying the wait condition by waiting a vacuous lease may lead to leaseholder old leaderserving a stale read, but this is ruled out by the user of Raft's LogMatching and LeaderCompleteness guarantees and the lease protocol of some embodiments of the present invention. In some embodiments, (1) the old leader cannot serve a read unless it has a lease, which means it committed an entry, and (2) a new primary cannot be elected unless it has everything committed in old primary's log included in its log. This means that in some embodiments, the new leader also learns of this lease, and will have to wait this out for ClientWrite.

In some embodiments, a precondition check prevents a corner case, where the deposed leader i becomes a leader again, while the interim leader j keeps serving local linearizable reads leveraging the lease on i from its previous term. If i could write new values leveraging its previous lease, this would cause j to serve stale-reads. However, this reincarnation of i has a new term (as per rules of Raft) which does not match the term on the existing lease corresponding to the old-term of i. Therefore, in some embodiments, the ClientWrite action stays disabled, and the newly minted leader i has to wait out the old lease to expire before it can accept any new writes. In the meantime, i (as well as j) can serve local linearizable reads by leveraging the old lease.

### 3. Local Linearizable ClientRead

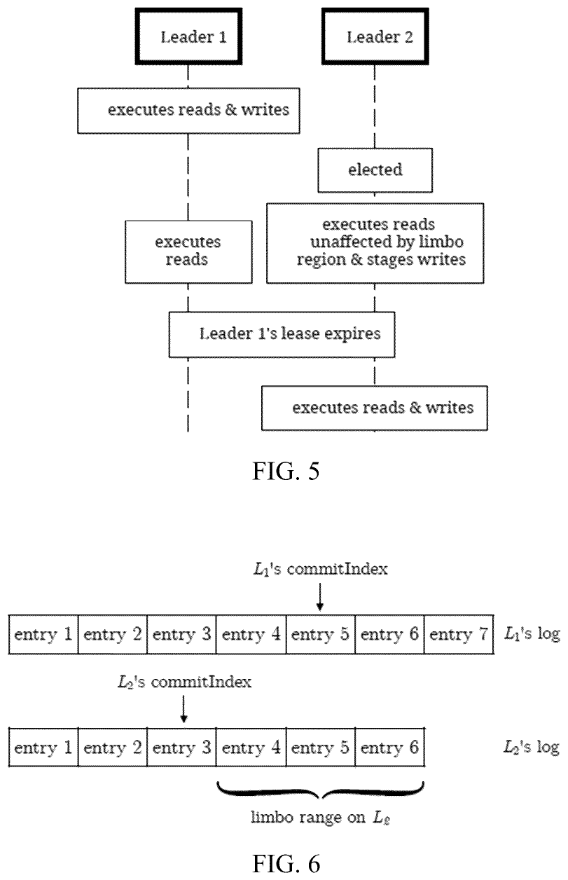

LeaseGuard allows multiple leaders to read simultaneously. For example, FIG. 5 illustrates transitions in the read/write capabilities of leaders. This feature significantly enhances read availability during leadership transitions, one of the major challenges prior systems are encountering. The idea of the limbo region to address the lag in the commitIndex between leader and followers during the leader transitions is further discussed below.

In some embodiments, the precondition to check for ClientRead (i) is:

$$ClientRead ( i ) ==$$

$$∧ state [ i ] = Primary$$

$$∧ lease [ i ] [ 2 ] >= clock$$

In some embodiments, if i knows of an outstanding/valid lease (either the one it installed or a lease installed by a previous leader) i can serve a ClientRead locally. That means any leader (the deposed leader that is unaware that it is deposed, or the new leader) that knows of an unexpired lease can serve the ClientRead locally. As shown in FIG. 5, this features allows the new leader to serve reads while the old leader holds the lease and serves reads as well.

In some embodiments, the new leader can serve local linearizable reads, leveraging the lease of the old leader, because the new leader is guaranteed to have all the committed entries in the old leader's log as per Raft's strong leader property. Moreover, since the old leader cannot commit new entries (by deposing the old leader, the new leader increased currentTerm in majority of the nodes), the local reads from the new leader will not be made stale by writes from the old leader.

Dually, the old leader serving reads with ClientRead is linearizable because due to the precondition lease [i] [2]≥clock, the new leader cannot accept ClientWrite and replicate/commit it, so the old leader can just serve from its log which reflects the latest committed state.

In some embodiments, the leader dispenses reads only using committed entries, and it does not need to wait out any pending update to be committed. The latest read is the most recent committed entry, and that value is, by definition, majority replicated and durable. A pending update did not get committed and acknowledged as committed to the client; therefore, linearizability is not violated by not reflecting that update.

In some embodiments, LeaseGuard supports speculative execution and reflects uncommitted entries in its state. However, the leader can still execute query at commit time thanks to the underlying multiversion concurrency control WiredTiger storage engine.

4. Addressing the Lag with the Limbo Region

Referring to FIG. 5, consider a leader 1 that has been deposed by a leader 2. The leader 1 may still believe it is the leader and can serve reads while its last committed entry is <Δ old. The leader 2 is guaranteed to have the entry and will not advance its own commitIndex until the entry is more than Δ old. Thus, the leader 1 has the latest committed data in the replica set while its lease is valid.

The leader 2 has all the entries the leader 1 committed. Since the leader 2 has the latest committed data, this might guarantee the leader 2's linearizable reads. However, the limbo region must be considered.

FIG. 6 illustrates limbo region in a new leader's log. The leader 2 has been elected in a later term than the leader 1. But, the leader 2 has not yet committed any entries, and its commitIndex lags that of the leader 1. The leader 2's “limbo region” is defined as the entries in the leader 2's log with indexes greater than the leader 2's commitIndex, up to the last entry in the leader 2's log when it was elected. Referring to FIG. 6, the leader 2 does not know where in the range [3,6] the leader 1's commitIndex falls. Thus, if the leader 2 acts pessimistically and executes client reads, it may return older data than the leader 1. This leads to violation of linearizability. If the leader 2 acts optimistically and applies all commands through index 6, it may return newer data than the leader 1, which also violates linearizability.

To guarantee linearizability in these scenarios, in some embodiments, LeaseGuard requires that a node executes reads only if they are unaffected by writes in the limbo region. This ensures both the leader 1 and the leader 2 to serve linearizable reads. Once the leader 1's lease expires, the leader 2 commits an entry, and the limbo region disappears.

In some embodiments, if a database supports multi-version concurrency control, the leader could execute a query on each version of its data corresponding to each entry in the limbo region and reject the query if any results are unequal.

In some embodiments, the optimization to address the limbo region is specific to the protocol. For example, LeaseGuard can optimize specific to Raft by relying on the Raft's leader completeness property. In the case of MultiPaxos and Viewstamped Replication, a different optimization is needed as these protocols do not guarantee that the leader has all committed entries. Because the leader election in Raft captures valuable information about the state of the system in the elected leader's log, LeaseGuard leverages this information to serve inherited lease reads.

### LeaseGuard's Linearizability

LeaseGuard's linearizability is verified under various scenarios, including with perfect clocks and skewed clocks.

1. Correctness with Perfect Clocks

A concurrent computation is linearizable if it is equivalent to a sequential computation that preserves the real-time ordering of operations. Raft without LeaseGuard optimization guarantees linearizability.

LeaseGuard alter's Raft's behavior in two ways. First, a leader may wait before committing recent writes and acknowledging them to the client. Raft has no real-time bound on when a leader commits an entry after it is majority-acknowledged, so this delay cannot break Raft's linearizability guarantee. Second, a leader can execute a read without contacting other notes. A proof for guaranteeing linearizability is shown below.

Definition 1 (Outstanding-Lease). A server s has an outstanding lease if lease [s]>=clock. A server s has an expired lease if lease [s]<clock. The leaseholder for that lease corresponds to the node that has currentTerm=lease [s][1], the first part of the tuple.

Definition 2 (Eligible-Writer). A primary j is an eligible writer if there is no primary with a higher currentTerm, and either j has an outstanding lease and j is the lease-holder, or j has an expired lease.

Lemma 1 (One-Lease). At any given time, there is at most one outstanding leaseholder. Proof. Assume for a contradiction that there are multiple leaseholders. Without loss of generality assume lease on 11 is the leaseholder with the earliest time, and pick another lease-holder and call it 12. That implies 11 accepted a ClientWrite with an earlier timestamp then 12. Hence 11 was a leader before 12 becomes a leader (because being a primary is the precondition for accepting a ClientWrite). That means due to Raft's LogMatching and LeaderCompleteness guarantees, 12 learns of 11's lease, and is bound to wait for its expiration before 12 can accept a ClientWrite and install a lease. This contradicts having multiple outstanding lease at any given time.

Lemma 2 (One-Writer). At any given time, there is at most one eligible writer. Proof. Due to Lemma 1 there can only be one outstanding leaseholder. Due to the precondition on ClientWrite, only that outstanding leaseholder is enabled to accept a ClientWrite. Hence there is at most one eligible writer at any given time.

Theorem 1 (Linearizable-Read). Any ClientRead returns a linearizable read. Proof. The precondition of the ClientRead (i) action states that i needs to be a primary. Lemma 1 states that there is at most one outstanding leaseholder. If there is no leaseholder, then i is not allowed to serve ClientRead (as per the precondition of ClientRead). There are two cases discussed below, both of which meet linearizability.

Case 1: If i is the leaseholder, then there cannot be an eligible writer except for i (due to Lemma 2), and i is guaranteed tmo have the most up-to-date committed state, and serving from that is linearizable.

Case 2: If i is not the leaseholder, but there exists a lease holder l, then i is guaranteed to have that lease and have all the committed entries of l due to Raft's LogMatching and LeaderCompleteness guarantees. Moreover, although l (only with currentTerm=lease [1] and not later reincarnations of l) could be the unique eligible writer (Lemma 2), since i has higher term, 1 is not able to accept/commit writes. So any read i serves is a linearizable read.

2. Correctness with Skewed Clocks

The single global clock model implies perfect clock synchronization. In reality, each server has its own clock, and achieving perfect synchronization of the clocks is hard due to slightly different crystal oscillation rates in local clocks, the oscillation frequency being inversely related to the operating temperature, and finally due to uncertainty in communication delay for clock synchronization that tries to eliminate such a drift. As a result, there is a small e error rate between any two clocks.

Lemma 1 is the only place clock synchronization factors into the correctness argument. If we can satisfy Lemma 1 in the presence of clocks with skews, the correctness reasoning is complete. To check this understanding, clock skew is added to the TLA+ model to investigate its effects, as described in https://github.com/muratdem/RaftLeaderLeases/blob/main/TLA/leaseRaft2.tla, the contents of which are herein incorporated by reference. When e is greater than A, it is possible to violate Theorem 1 (linearizable read) through a violation of Lemma 1. The new leader with a fast clock, which is epsilon>Δ ahead of others, concludes that the lease belonging to the old leader expired and commits a ClientWrite. On the other hand, the deposed leader finds the lease still valid according to its clock, and serves a stale ClientRead.

In order to satisfy Lemma 1 in the presence of clock skew, the lease protocol should compensate for the maximum e for waiting out the lease period A. In deployments, the maximum e is bounded by a couple milliseconds, because clock synchronization protocols like NTP and PTP fight off the clock drift by checking the time with precise time sources (atomic clocks and/or GPS clocks) over the network (as described in J. C. Corbett, J. Dean, M. Epstein, A. Fikes, C. Frost, J. J. Furman, S. Ghemawat, A. Gubarev, C. Heiser, P. Hochschild et al., “Spanner: Google's globally distributed database,” ACM Transactions on Computer Systems (TOCS), vol. 31, no. 3, p. 8, 2013), and recently even microsecond clock synchronization is achieved. Since the lease period A is on the order of seconds, with typical selections being 5-10 seconds, and clock drift is bounded, by compensating for the max e in the lease wait-out period, safety of the leases is preserved through Lemma 1.

As discussed below, there is an alternative way of satisfying Lemma 1 without using clock synchronization and wall clock, and instead only using the monotonic clock counter through System.nanoTime.

### 3. Correctness in the Presence of Reconfigurations

The correctness of leader leases can be shown to be preserved during reconfigurations by showing that in Raft, reconfiguration is orthogonal to replication as explained below. In Raft, a reconfiguration is only enabled after an OpLogCommitment by the leader, which implies the new leader already established a lease. Since reconfiguration in Raft is performed by only addition or removal of a replica, the lease shows itself in the majority of nodes, and Lemma 1 and Lemma 2 hold.

The node removal case is easy to see. When decrementing from an odd to an even number of nodes (e.g., from 5 to 4) the majority in the new configuration stays the same and the lease is guaranteed to be seen by the new configuration. When decrementing from an even to an odd number (e.g., from 4 to 3), the majority in the old configuration is larger, and hence is guaranteed to intersect with the majority in the new configuration, and the lease is maintained in the majority.

Node addition is similar. When incrementing from an odd to an even number of nodes (e.g., from 3 to 4), the majority in the new configuration is larger, and is guaranteed to see the lease, and if a new leader emerges it will adopt the lease. If the old leader continues, the lease gets propagated to the new majority. Note that another reconfiguration cannot happen until an OpLogCommitment by the leader, so the lease is guaranteed to be in the new majority. When incrementing from an even to an odd number (e.g., from 4 to 5), the majority remains the same and lease is maintained in the majority.

### Extensions and Optimizations of LeaseGuard

### 1. Automatic Lease Extension

LeaseGuard extends leases automatically through write operations, but a lease expires after Δ duration with no writes. When writes are rare, the leader can write a no-op to reestablish its lease whenever needed to serve a read, or (to avoid cold starts) write a no-op periodically to maintain its lease. In some embodiments, the later approach is adopted.

For planned leader transitions (e.g. for rolling upgrades and other maintenance tasks), the outgoing leader can relinquish its lease by committing an “end-lease” entry as its final act of leadership. The next leader can execute reads and writes without restriction.

### 2. Choosing Election Timeout and Lease Duration

LeaseGuard allows the election timeout ET and lease duration Δ to be tuned independently. FIG. 7 illustrates the effect of lease duration on availability. Referring to FIG. 7, if ET is a fixed number, it is best to set Δ=ET. If Δ<ET and writes are rare, the leader must extend its lease more often without any benefit from the short A. If Δ>ET, there is a period after an election when the new leader has no lease.

However, LeaseGuard tolerates this better than conventional protocols, because the elected leader can still serve linearizable reads using the inherited lease optimization and perform deferred commit writes. Regardless of ET, a leader might be deposed at any time, perhaps by a human operator or a failure detector.

In some embodiments, LeaseGuard enables lease protocols combined with failure detectors, since LeaseGuard improves availability after an election.

3. Leases without Bounded-Uncertainty Clocks

LeaseGuard can be implemented using local timers with bounded drift rates, without synchronized clocks of bounded uncertainty. All nodes must know some value ϵ, the maximum amount that their clocks can gain or lose while measuring a duration of A. Whenever a leader creates or a follower replicates an entry, it starts a timer to track that entry's age. The leader's timer starts as soon as it creates an entry, before any followers can replicate the entry, so the leader's timer expires before any follower's timer for that entry. LeaseGuard's rules can be revised to use timers instead of time intervals: a leader can advance its commitIndex or serve reads so long as its last entry in any previous term is >Δ+ϵ old, and the last committed entry in its own term is <Δ−ϵ old.

Timers suffice for LeaseGuard with deferred commit writes, but not for inherited lease reads. Suppose a leader L1 is deposed by L2, which commits no entries before it is deposed by L3. Due to a network partition, L2 is unaware of L3's election; L3 is elected by a quorum that does not include L2. Now L2 and L3 are both leaders for a time. They may disagree on when L1's lease expires, based on when they last replicated an L1 entry when they were followers. This view asymmetry can lead to a linearizability violation: L3 believes L1's lease has expired, so L3 commits entries, while L2 thinks the lease it inherited from L1 is still valid, so L2 serves inherited lease reads from stale data.

Thus, systems must have access to clocks with bounded uncertainty to implement inherited lease reads. With such clocks, L1 stores a time interval in each entry, and there is no ambiguity about whether its entries are >Δ old.

4. MongoDB Specific Optimizations In addition to the general contributions discussed above, some embodiments also provide MongoDB specific benefits. One such benefit is that the default consistency options (w: majority, rc: local) will guarantee read-your-writes. This is not guaranteed by existing systems. Anomalies are more common with Invisible Sharding, which makes this problem more urgent. The problem is if there are two nodes that think they're primary, and a write is made to the new primary, then read from the old one. If there is a write and then read with the same MongoClient, the MongoClient, in some embodiments, remembers the highest electionId and refuses to switch from a new primary to an old one; thus the default options do guarantee read-your-writes. But with application restarts, multiple MongoClients, and/or multiple mongoses there are no guarantees. Invisible Sharding means everyone uses multiple mongoses.

In some embodiments, there are more efficient change streams in sharded clusters. Suppose there are two shards A and B, where A receives frequent writes, and B is idle. Some client is tailing a change stream, via mongos. Mongos receives a batch from A's primary, with latest optime t. To return results in order, mongos must confirm B's primary PB won't write oplog entries before t; only then can mongos reply to the client. In existing systems, PB is not sure if it is the real primary, so it blocks while the periodic no-op writer creates and commits an entry after t. This hurts latency significantly for some customers. With the leader leases of some embodiments, PB will already know it has the latest writes.

### Simulation Results

The performance of LeaseGuard is assessed under the simulation. The simulation simulates a client, where any number of clients can concurrently communicate with the Raft leader.

Three metrics of the performance is latency, availability, and skewness. The latency assesses how the leases affect the latency of linearizable reads and writes. The availability assesses how various consistency mechanisms affect availability during leader transitions. The skewness assesses how workload skewness affects read availability during leader transitions.

FIG. 8 illustrates the effect of network latency on read/write latency of the simulation of 50 clients, where half do a single Read operation and half do a single ListAppend. As shown in FIG. 8, the lease configuration (using LeaseGuard) enables instant linearizable reads served locally, in comparison to the inconsistent and quorum configurations. This demonstrates LeaseGaurd's improved consistency with no overhead.

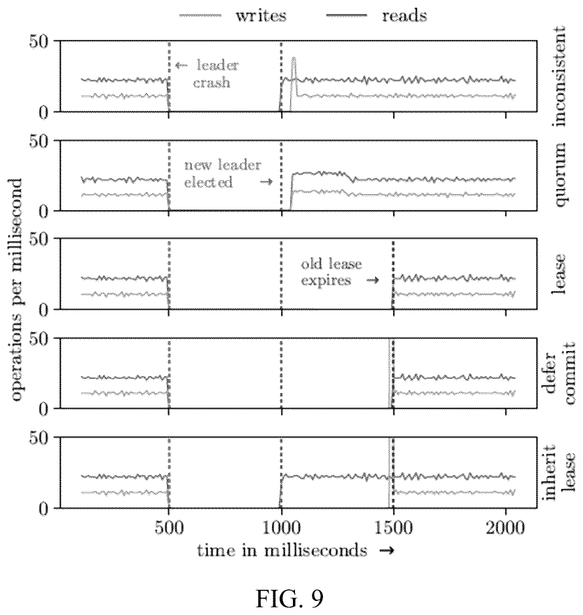

FIG. 9 illustrates availability of the simulation, where a 3-node replica set is created and executes the workload. The simulation is set that after 500 ms, the leader crashes; 500 ms later, another leader is elected, and 500 ms after that, the old leader's lease expires. The middle row in FIG. 9 shows the availability of the lease configuration using LeaseGuard but without inherited read leases or deferred-commit writes. After the election, reads and writes fail until 1500 ms when the new leader acquires its lease. In the defer commit implementation, the new leader begins to accept writes, create log entries, and replicate them as soon as it is elected while waiting for the old lease to expire.

Two optimizations, defer commit and inherit lease (last two rows of FIG. 9), help the replica set return to steady state more quickly after a leader failure. For example, the deferred commit write optimization enables quick stabilization than the unoptimized leases. In the inherit lease implementation, the new leader can serve linearizable reads as soon as it is elected. There are few writes in progress when the leader dies, so the new leader has a small limbo region which does not significantly interfere with inherited read leases. The inherited lease read optimization restores read availability sooner after an election.

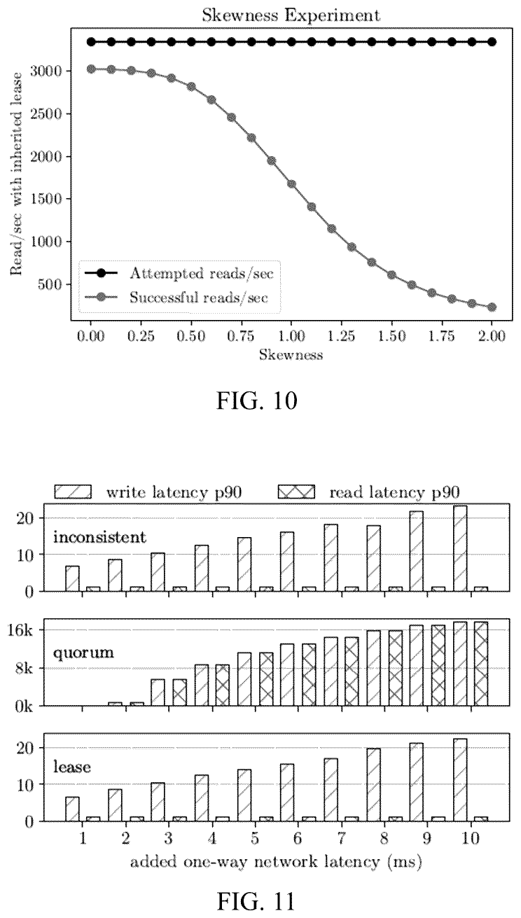

FIG. 10 illustrates the effect of workload skewness on read throughput. The skewness ranges from Zipfian skewness 0 to 2 across 1000 keys. When the leader crashes and a new one is elected, it can use an inherited lease to read any data written by the prior leader, except for data affected by log entries in the limbo region. The simulated read shown in FIG. 10 displays the results upon placing 100 log entries into the limbo region and measuring the read throughput on the new leader.

### Experimental Evaluation

To further evaluate the performance, the LeaseGuard is implemented in the LogCabin codebase, the reference implementation of Raft. The latency and availability are assessed in this experimental evaluation.

FIG. 11 illustrates the effect of network latency on read/write latency from the experimental evaluation. As in the simulation result shown in FIG. 8, the experimental performance of the lease configuration using the LeaseGuard outperformed, permitting consistent reads and writes with zero overhead.

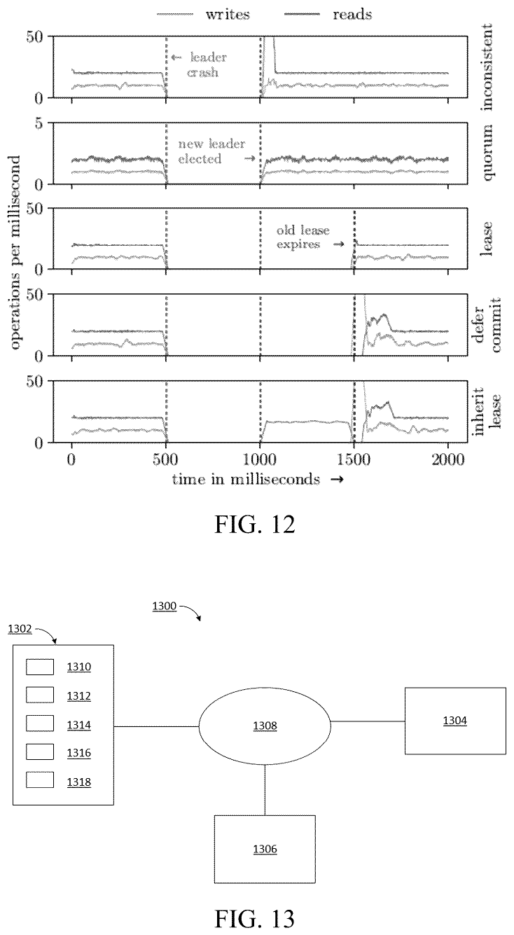

FIG. 12 illustrates availability from the experimental evaluation. The lease (middle row in FIG. 12) without optimization shows unavailable system after the election until the old leader's lease expires. As in the simulation result shown in FIG. 9, LeaseGuard optimization (defer commit and inherit lease) shows improved read availability while the new leader waits for a lease.

### Additional Implantation Detail

Various aspects and functions described herein may be implemented as specialized_hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

For example, various aspects, functions, and processes may be distributed among one or more computer systems configured to provide a service to one or more client computers, or to perform an overall task as part of a distributed system, such as the distributed computer system 1300 shown in FIG. 13. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 13, there is illustrated a block diagram of a distributed computer system 1300, in which various aspects and functions are practiced. As shown, the distributed computer system 1300 includes one or more computer systems that exchange information. More specifically, the distributed computer system 1300 includes computer systems 1302, 1304, and 1306. As shown, the computer systems 1302, 1304, and 1306 are interconnected by, and may exchange data through, a communication network 1308. The network 1308 may include any communication network through which computer systems may exchange data. To exchange data using the network 1308, the computer systems 1302, 1304, and 1306 and the network 1308 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST, and Web Services. To ensure data transfer is secure, the computer systems 1302, 1304, and 1306 may transmit data via the network 1308 using a variety of security measures including, for example, SSL or VPN technologies. While the distributed computer system 1300 illustrates three networked computer systems, the distributed computer system 1300 is not so limited and may include any number of computer systems and computing devices, networked using any medium and communication protocol.

As illustrated in FIG. 13, the computer system 1302 includes a processor 1310, a memory 1312, an interconnection element 1314, an interface 1316 and data storage element 1318. To implement at least some of the aspects, functions, and processes disclosed herein, the processor 1310 performs a series of instructions that result in manipulated data. The processor 1310 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 1310 is connected to other system components, including one or more memory devices 1312, by the interconnection element 1314.

The memory 1312 stores programs (e.g., sequences of instructions coded to be executable by the processor 1310) and data during operation of the computer system 1302. Thus, the memory 1312 may be a relatively high performance, volatile, random access memory such as a dynamic random access memory (“DRAM”) or static memory (“SRAM”). However, the memory 1312 may include any device for storing data, such as a disk drive or other nonvolatile storage device. Various examples may organize the memory 1312 into particularized and, in some cases, unique structures to perform the functions disclosed herein. These data structures may be sized and organized to store values for particular data and types of data.

Components of the computer system 1302 are coupled by an interconnection element such as the interconnection element 1314. The interconnection element 1314 may include any communication coupling between system components such as one or more physical busses in conformance with specialized or standard computing bus technologies such as IDE, SCSI, PCI and InfiniBand. The interconnection element 1314 enables communications, including instructions and data, to be exchanged between system components of the computer system 1302.

The computer system 1302 also includes one or more interface devices 1316 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 1302 to exchange information and to communicate with external entities, such as users and other systems.

The data storage element 1318 includes a computer readable and writeable nonvolatile, or non-transitory, data storage medium in which instructions are stored that define a program or other object that is executed by the processor 1310. The data storage element 1318 also may include information that is recorded, on or in, the medium, and that is processed by the processor 1310 during execution of the program. More specifically, the information may be stored in one or more data structures specifically configured to conserve storage space or increase data exchange performance. The instructions may be persistently stored as encoded signals, and the instructions may cause the processor 1310 to perform any of the functions described herein. The medium may, for example, be optical disk, magnetic disk or flash memory, among others. In operation, the processor 1310 or some other controller causes data to be read from the nonvolatile recording medium into another memory, such as the memory 1312, that allows for faster access to the information by the processor 1310 than does the storage medium included in the data storage element 1318. The memory may be located in the data storage element 1318 or in the memory 1312, however, the processor 1310 manipulates the data within the memory, and then copies the data to the storage medium associated with the data storage element 1318 after processing is completed. A variety of components may manage data movement between the storage medium and other memory elements and examples are not limited to particular data management components. Further, examples are not limited to a particular memory system or data storage system.

Although the computer system 1302 is shown by way of example as one type of computer system upon which various aspects and functions may be practiced, aspects and functions are not limited to being implemented on the computer system 1302 as shown in FIG. 13. Various aspects and functions may be practiced on one or more computers having a different architectures or components than that shown in FIG. 13. For instance, the computer system 1302 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 1302 may be a computer system including an operating system that manages at least a portion of the hardware elements included in the computer system 1302. In some examples, a processor or controller, such as the processor 1310, executes an operating system. Examples of a particular operating system that may be executed include a Windows-based operating system, such as, the Windows-based operating systems, available from the Microsoft Corporation, a MAC OS System X operating system or an iOS operating system available from Apple Computer, one of many Linux-based operating system distributions, for example, the Enterprise Linux operating system available from Red Hat Inc., or a UNIX operating system available from various sources. Many other operating systems may be used, and examples are not limited to any particular operating system.

The processor 1310 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Java, C++, C #(C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture or programming language.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Use of at least one of and a list of elements (e.g., A, B, C) is intended to cover any one selection from A, B, C (e.g., A), any two selections from A, B, C (e.g., A and B), any three selections (e.g., A, B, C), etc., and any multiples of each selection. Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A database management system comprising:
a plurality of nodes, at least one of the plurality of nodes configured to:
initiate a request to become a new leader of a lease;
receive a client write request;
service the client write request only if the lease belongs to a current term of the at least one node or if the lease belongs to another of plurality of nodes serving as an old leader and is expired; and
decline the client write request if the lease belongs to the old leader and is not expired.

2. The database management system of claim 1 further comprising:
a component to become a leader, wherein the initiate a request to become a new leader of a lease invokes the become leader component.

3. The database management system of claim 2 further comprising:
a plurality of logs corresponding to the plurality of nodes, each of the plurality of logs comprising a plurality of entries.

4. The database management system of claim 3 wherein the component to become a leader is configured to permit the at least one node to become the new leader only if the log corresponding to the at least one node comprises the plurality of entries of the log of the node that is the old leader.

5. The database management system of claim 4 further comprising a component for matching logs configured to indicate that a portion of the plurality of entries of a first log of the plurality of logs corresponding to a first node of the plurality of nodes is the same as a portion of the plurality of entries of a second log of the plurality of logs corresponding to a second node of the plurality of nodes.

6. The database management system of claim 5 further comprising:
a component for ensuring leader completeness configured to ensure that the plurality of entries in a log of the new leader is the same as a plurality of entities in a log of the old leader.

7. The database management system of claim 6 wherein the at least one node is further configured to determine whether the lease belongs to the old leader by invoking the component for matching logs and the component for ensuring leader completeness.

8. The database management system of claim 7 wherein the lease comprises a current term and an expiration time.

9. The database management system of claim 8 wherein the at least one node is further configured to extend the expiration time of the lease after the at least one node becomes the new leader.

10. The database management system of claim 9 further comprising:
a component configured to get one or more of the plurality of entries and a component configured to commit the one or more of the plurality of entries wherein the extend the expiration time of the lease comprises invoking the component to get entries and the component to commit entries.

11. The database management system of claim 1 wherein the old leader is configured to:
receive a client read request; and
service the client read request if the lease belongs to the old leader and is not expired.

12. The database management system of claim 1 wherein the new leader is configured to:
receive a client read request, wherein the client read request specifies a query;
determine if the query corresponds to one or more entries in a limbo region of the new leader; and
reject, upon the determination, the client read request.

13. A computer-implemented method for managing a database comprising a plurality of nodes, the method comprising:
initiating a request by at least one of the plurality of nodes to become a new leader of a lease comprising a current term and an expiration time;
receiving a client write request at the at least one node;
servicing the client write request at the at least one node if the lease belongs to the current term of the at least one node or if the lease belongs to another of the plurality of nodes serving as an old leader and is expired; and
declining the client write request at the at least one node if the lease belongs to the old leader and is not expired.

14. The computer-implemented method for managing a database of claim 13 further comprising a plurality of logs corresponding to the plurality of nodes, each of the plurality of logs comprising a plurality of entries.

15. The computer-implemented method for managing a database of claim 14 further comprising permitting the at least one node to become the new leader only if the log corresponding to the at least one node comprises the plurality of entries of the log of the node that is the old leader.

16. The computer-implemented method for managing a database of claim 15 further comprising ensuring that a portion of the plurality of entries of a first log of the plurality of logs corresponding to a first node of the plurality of nodes is the same as a portion of the plurality of entries of a second log of the plurality of logs corresponding to a second node of the plurality of nodes.

17. The computer-implemented method for managing a database of claim 16 further comprising ensuring that the plurality of entries in a log of the new leader is the same as a plurality of entities in a log of the old leader.

18. The computer-implemented method for managing a database of claim 17 further comprising extending the expiration time of the lease after the at least one node becomes the new leader.

19. The computer-implemented method for managing a database of claim 18 wherein the extending the expiration time of the lease comprises:
getting one or more of the plurality of entries; and
committing the one or more of the plurality of entries.

20. The computer-implement method for managing a database of claim 1 further comprising:
receiving a client read request at the old leader; and
servicing the client read request if the lease belongs to the old leader and is not expired.
